(19) United States
(12) Patent Application Publication
(10) Pub. No.: US 2014/0246505 A1
(43) Pub. Date: Sep. 4, 2014

(54) APPARATUS FOR AND METHOD OF WATER DELIVERY

(71) Applicant: Marshall Neel, Albuquerque, NM (US)

(72) Inventor: Marshall Neel, Albuquerque, NM (US)

(21) Appl. No.: 13/784,485

(22) Filed: Mar. 4, 2013

(51) Int. Cl. B05B 15/06; A01G 25/02

(52) U.S. Cl. CPC B05B 15/061; A01G 25/02
USPC 239/1; 239/283

(57) ABSTRACT

The present invention relates generally to a water delivery system comprising a rigid support, an adjustable extension attachably disposed on a base wherein a water supply tube is disposably attached to the rigid support and within the extension. The water supply tube is flexibly and variably positioned from ground level to any desired height. Any type of sprinkler, sprayer, or other kind of water distributor is attachably secured to the water supply tube to provide water to vegetation or containers inexpensively, efficiently, and esthetically.

### CROSS-REFERENCE TO RELATED APPLICATION

This application claims the benefit of U.S. Provisional Patent Application 61/606,388, entitled “Adjustable, decorative support for the elevation of drip irrigation emitters and sprinklers/sprayers,” filed on Mar. 3, 2012, and the subject matter thereof is incorporated herein by reference thereto. This application also references the Applicant's U.S. Provisional Patent Application 61/574,480 entitled “Adjustable, decorative support for the elevation of drip irrigation emitters and sprinklers/sprayers,” filed on Aug. 3, 2011, and expressly abandoned on Mar. 2, 2012.

### TECHNICAL FIELD

The present application relates generally to the field of brackets. More specifically, the present invention comprises a bracket that supports a water supply tube that delivers water significantly above the elevation level of the main water supply tube of a drip irrigation system or any other irrigation water delivery systems. Additionally, the present invention relates generally to drip irrigation systems, and more particularly to an adjustable, decorative bracket that supports the elevation of water delivery and drip irrigation emitters and sprinklers/sprayers.

### BACKGROUND ART

The origin of drip irrigation dates back centuries to the Middle East with devices and methods to irrigate plants effectively with extremely limited water supplies. Drip irrigation evolved from using unglazed clay pots filled with water that were buried next to plant roots to the presently used modern drip irrigation systems consisting of polymer tubing and plastic drip irrigation fittings of various sizes and shapes.

Today's commercial industrial and residential drip irrigation systems capably and efficiently supply water to vegetation at ground level through a network of tubing and various types of drippers, emitters, and sprayers. The water is typically delivered at the elevation level of a main water supply tube of a drip irrigator, which is typically located at ground level. A typical drip irrigation system consists of a valve connected to a water supply that controls the delivery of water to an area to be irrigated. The valve is usually located at ground level and typically connected to a timer that opens and closes it on some preset schedule. A main irrigation tube extends from this valve throughout the area to be irrigated. This tube is attached to the valve at one end and capped at the other end so it maintains pressure when the valve is opened. This main tube either lies on top of the ground or is buried just beneath the ground surface. Smaller tubes are then attached to this main tube and extended to exactly where the water is to be delivered, usually right at the root of the plants to be watered, where some kind of drip emitter is attached. All of the components of the typical drip irrigation system are located at ground level.

Practical application of currently known networks of tubing, drippers, emitters, and sprayers often demands that dripper, sprayer, or sprinkler fittings be elevated above the elevation level of the main water supply tube of the distribution system to maximize usefulness and effectiveness of the delivery method.

Currently used devices that irrigate vegetation with a drip irrigation system with an elevated delivery point of water, such as spraying water from above, consist of a semi-rigid or rigid plastic or polypropylene tube or “riser,” generally six inches to eighteen inches in length, that is supported by a ground stake or other means to elevate the device above the landscape to be watered. A mini sprinkler or sprayer is attached at the top of the stake and the water supply tube is attached at the bottom to connect to a main water source, which enables the sprinkler or sprayer to be elevated above vegetation, spray over the vegetation, and thus cover a large area of ground and vegetation, with the caveat that the vegetation so watered is suited to this type of water delivery from above rather being suited to be soaked via the soil under the vegetation or dripping at ground level near the roots of the vegetation.

There are many disadvantages to currently known methods of watering vegetation. The plastic risers are limited in height, extending no more than eighteen inches above the ground. These risers typically are placed directly in the vegetated area where maintenance requires access that may damage or trample plants. Additionally, to utilize the mobility these methods offer often requires a considerable length of tubing to facilitate placement throughout the vegetated area. Long stretches of loose tubing are inconvenient to place, create tripping hazards, and the movement of excess tubing damages plants. The tubing is also prone to damage by animals and by routine work in the vegetated area performed by maintenance workers using tools such as shovels or spades. In lieu of regularly relocating an elevated sprayer or sprinkler currently used, multiple sprayers can be used on the system, which reduces the pressure in the overall system and also results in coverage overlap, thus increasing water use and overwatering some areas.

An alternative method to water delivery to vegetation also currently used is attaching a thin metal rod available in lengths up to thirty-six inches with a sprinkler/sprayer attached at one end of the rod, where the sprinkler/sprayer attaches to a water supply tube. The thin metal rod can then be inserted into the ground sufficiently deep enough that the rod will not fall over, with a water supply tube attached at the top of the rod to feed the sprayer or sprinkler. Thus, the sprinkler or sprayer is elevated as high as thirty inches above the ground. The disadvantage with this method of elevating the water distribution is potential instability of the rod, because the water supply tube attached at the top of the rod may pull on the rod. This configuration is also easily toppled by people tripping over this device or by animals, birds, or strong winds.

Both of the above mentioned configurations of devices currently used often require that the rods used in the devices are positioned in the middle of the vegetation which makes it difficult to reach, reset, or adjust the rods without damaging vegetation. There is a substantial risk of damage to the water supply tube, emitter, sprinkler or sprayer, and/or to the vegetation when these systems fall or are knocked down and are not quickly reset. Additionally, tubing that is cut or otherwise damaged results in water waste at the site and a resulting loss of pressure. Additionally, soil might be introduced into and contaminate the distribution system resulting in clogged emitters, sprayers or sprinklers that disrupt water delivery.

Large-scale commercial or agricultural users of watering systems such as nurseries that elevate irrigation above vegetation use various structures or frameworks built from wood or other materials. A water supply tube is supported above the vegetation and sprinklers or sprayers are attached at regular intervals to these structures, providing a uniform distribution of water to the plants located below. These kinds of systems must be custom built specifically for the building, greenhouse, or field in which they will be utilized and are expensive.

Currently available devices for elevating the height of water delivery from an irrigation system are inadequate for delivery of water to a receptacle above ground, particularly one located higher than three feet above ground. Currently known devices that elevate an emitter, sprayer or sprinkler to deliver water to areas on a plane higher than that of the drip irrigation system, such as a raised garden, hanging planter, or a bird bath or pet or wildlife water receptacle, is a do-it-yourself endeavor, that requires a customized approach. The endeavor usually consists of attaching a length of distribution tubing to a main water supply source and then draping the tube to a desired height above the vegetation, or using tape or wire to secure the distribution tube to the base of a bird bath or other receptacle and then running the tube up and over the lip of the bird bath or receptacle where the tube is secured or anchored in some way in order to distribute water as desired.

Many methods might be used in attempts to secure a water distribution tube to a rod, a basin, or some other structure, including but not limited to hooks, brads, screws, nails, tape, wire, string, and clamps. The tube might be similarly attached to more than one separate upright structures of some kind, in some fashion, to secure the tube at the desired height above vegetation and then position and hold the tube end in place in some way in order to direct water in the manner and direction desired. For example, in the case of distributing water to a free-standing basin or receptacle such as a bird bath, this might be as simple as draping the tube over the lip of the bird bath basin and securing it to the edge of the basin in some fashion. This method can be precarious, even though functional. The tube could be accidentally kicked loose, or come loose from any natural force such as wind or from action by birds or other animals, thus failing to fill the receptacle as desired and wasting water if not promptly corrected.

Sun and weather can quickly prove corrosive to tape and result in the tube falling from its desired position. Water is wasted and pressure reduction results from an open tube end on the system, causing other emitters or sprinklers on the same system not to receive adequate water in cases where the emitter is dislodged or comes loose, potentially resulting in injury and damage to vegetation. These flaws become particularly likely as the height of the tubing above the plane of the primary distribution system increases.

The apparatus of the present invention overcomes the disadvantages of those irrigation systems currently known and used. Advantages of the present invention include providing an apparatus and method for securing and directing water flow in drip irrigation or other water supply systems significantly above the plane of the water supply that is safe, stable, adjustable, flexible, and that does not risk damage to vegetation. The apparatus of the present invention extends the functionality of an irrigation system beyond simple irrigation to filling many types of receptacles for other purposes and comprises an apparatus that is easily maintained with off-the-shelf parts by “do-it-yourselfers.”

Further, the apparatus of the present invention is aesthetically pleasing and positively contributes to the overall appearance and design of a well-managed and planned yard, vegetation plot, or garden area. The horizontal displacement of the apparatus comprising tubing to a position displaced from its support is hidden within a cavity disposed in the apparatus and provides a clean appearance.

Advantages of the present invention include providing tubing that is adjusted horizontally, is securely supported, and is directed upward, downward, or in any other desired configuration, and is disposed on the apparatus in a location that provides for water delivery as required or desired. The tubing is securely fastened, either on one side of a supporting element comprising a rod or any other rigid support, or disposed through an opening in the supporting element, and fastened on an opposite side of the supporting element to any height required or desired.

Another advantage of the apparatus of the present invention is that it supplies water significantly above the elevation level of a main water supply tube of a drip irrigation system or any other irrigation water delivery system, as well as at ground level. This allows the apparatus of the present invention to be adapted to be useful in a plurality of scenarios, including but not limited to a terraced landscape, a birdbath, or a hanging pot.

The resulting apparatus of the present invention is thus cost-effective, uncomplicated, highly versatile, and effective, and comprises adapted components currently known for timely, efficient, and economical manufacturing, application, and utilization.

A number of advantages of one or more aspects of some embodiments of the adjustable, decorative support bracket of the present invention include the following.

Water supply emitters, sprinklers, sprayers or other fittings are elevated to a desired or required height greater than the eighteen (18) inches of poly risers currently used, or the thirty (30) inches of a wire tube support currently used. Water distribution is directed upward, downward, horizontally, or in a plurality of directions from an elevated position to suit a desired purpose.

A sturdy, stable, attractive, adjustable, flexible, and easily movable method for irrigating or water delivery is provided for watering plants in elevated gardens or hanging baskets and sprinkling or spraying water from a location above vegetation. A sturdy, stable, attractive, adjustable, flexible, and easily movable method is provided by the present invention to adapt an irrigation system to non-irrigation uses including filling elevated water receptacles such as bird baths, pet dishes, and small wildlife watering troughs.

Certain amounts of water are also distributed to a receptacle, raised planter, vegetation plot, or garden at precise times during the day or night using timers and electronic valve systems common in water delivery systems.

A stable support element is anchored outside the area to be watered instead of inside the area to be watered, where plants might be damaged in moving, repairing or replacing elements comprised by the present invention. An adaptable support comprising a vertical support visually enhances any environment and secures and hides the distribution tube. The water supply tubing is secured to prevent accidents or damage to the apparatus of the present invention resulting from tripping or animals. The present invention comprising tubing and fittings is adaptable, easily modified, maintained and replaced by laypersons and with readily available off-the-shelf parts.

Heat, cold, water, weather, and sun resistance is provided by using the present invention. An inexpensive and durable solution to elevating this type of water distribution is provided by using the present invention. Simple vertical and horizontal adjustment is provided by using the present invention.

Tube support uprights are used that, in various embodiments, provide additional utility such as fencing, wildlife perches, habitats, or feeders, sun shades, or planters. Tube support uprights are used that in various embodiments are fitted with decorative or artistic attachments or accessories to enhance appearance or functionality. Water is delivered in an environmentally friendly manner that reduces water waste and supports wildlife.

Certain embodiments of the invention have other steps or elements in addition to or in place of those mentioned above. The steps or element will become apparent to those skilled in the art from a reading of the following detailed description when taken with reference to the accompanying figures.

### SUMMARY OF THE INVENTION

The present invention comprises a

A water delivery system comprising:
a bracket comprising:
   a support;
   a base variably attached to said support;
   an extension attachably disposed on said base; and
a tube disposed adjacent to said support and through an opening within said base and said extension.
   2. The tube of claim 1 further comprising a water delivery tube.
   3. The base of claim 1 wherein said base is variably attached to said support to provide water at a variety of heights.
   4. The water delivery system of claim 1 further comprising fasteners securing said tube to said support.
   5. The water delivery system of claim 1 further comprising a sprinkler attached to an end of said water delivery tube.
   6. The water delivery system of claim 1 further comprising a sprayer attached to an end of said water delivery tube.
   7. The base of claim 1 comprising a support arm connecting upper and lower support panels
   8. A method of delivering water comprising:
providing a bracket attached to a support;
variably attaching a base to the support;
attaching an extension to the base; and
attaching a tube to the said support and through an opening within the base and the extension.
   9. The method of delivering water of claim 8 further comprising attaching a sprinkler to one end of the water delivery tube and attaching a main water supply to the other end of the water delivery tube.
   10. The method of delivering water of claim 8 wherein the water delivery tube is directed vertically.
   11. The method of delivering water of claim 8 wherein the water delivery tube is directed horizontally.
   12. The method of delivering water of claim 8 wherein the water delivery tube is positioned at a variable height above vegetation.

### BRIEF DESCRIPTION OF THE DRAWINGS

FIG. 1 illustrates a side view of the bracket of the present invention comprising a min-sprayer;

FIG. 2 illustrates side view of the bracket of the present invention comprising a drip irrigator;

FIG. 3 illustrates a perspective view of the bracket of the present invention comprising an extension fully extended;

FIG. 4 illustrates a perspective view of the bracket of the present invention comprising an extension fully retracted;

FIG. 5 illustrates a perspective view of one side of one embodiment of a base of the present invention;

FIG. 6 illustrates a perspective view of another side of one embodiment of a base of the present invention;

FIG. 7 is a top and side perspective view of one embodiment of the extension of the present invention shown in FIG. 2;

FIG. 8 is a bottom and side perspective view of one embodiment of the extension of the present invention shown in FIG. 2;

FIG. 9 is a top and side perspective view of one embodiment of a vertical support housing of the present invention;

FIG. 10 is a top perspective view of one embodiment of a vertical support housing of the present invention; and

FIG. 11 illustrates a top and front exploded perspective view of the present invention.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail.

The figures illustrating embodiments of the system are semi-diagrammatic and not to scale and, particularly, some of the dimensions are for the clarity of presentation and are shown exaggerated in the drawing figures.

The same numbers are used in all the drawing figures to relate to the same elements. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the bracket system, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane, as shown in the figures. The term “on” means that there is direct contact among elements.

In one or more embodiments of the present invention, the drip tube support bracket of the present invention comprises a base and an extension. The base is formed such that it can be attached to a vertical support or structure at some height above the plane of a drip irrigation or other water supply system so that it securely houses an extension that is adjusted horizontally to extend the reach of the end of the bracket, and thus the delivery point of water, away from the support or structure.

In one embodiment of the present invention, a base comprises a side comprising an opening through which an extension is disposed in a similarly shaped and sized indentation and also disposed in an opening in a side of the base. The method of use of the apparatus of the present invention comprises moving the extension through the opening in the base and guiding the extension so that it is supported, stable, and is anchored at a plurality of extension points. A water supply tube is subsequently directed from the plane of the water supply by attaching the tube to a rigid supporting structure as well as the indentation. The tube is then disposed within one end of the extension at the location where an emitter or other water distribution fitting is attachably disposed.

One end of the extension comprises an insertion element that accommodates a water supply tube in a plurality of dispositions, including a downward orientation, in order, for example, to fill a basin or receptacle, or an upward orientation, for example, in order to support a spray or sprinkler attachment for water distribution.

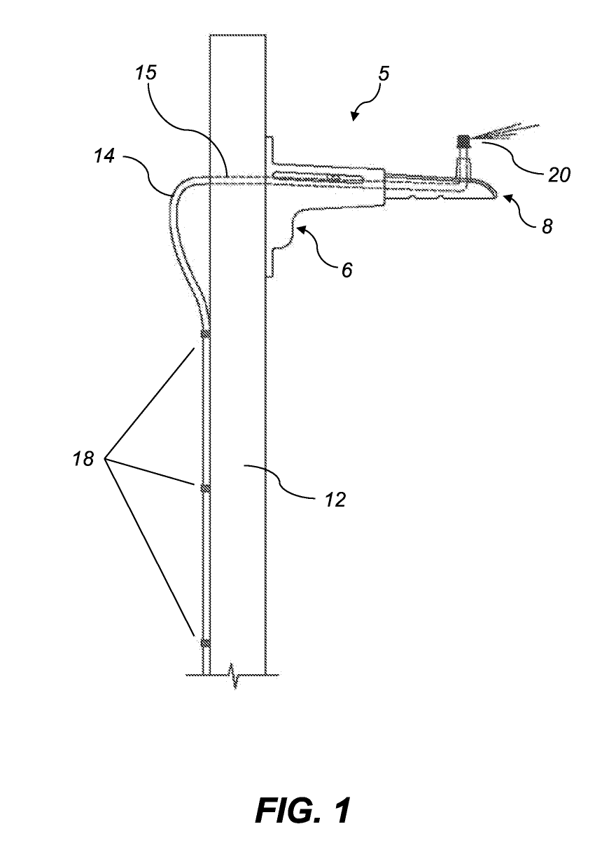

One embodiment of the bracket of the present invention is illustrated in FIG. 1 through FIG. 11.

FIG. 1 is a side view illustrating bracket 5 comprising a plurality of elements. Bracket 5 is disposably attached to a supporting element comprising a drip irrigation tube which is disposed in an opening disposed in the support. In this preferred embodiment, bracket 5 comprises sprayer 20 that supplies water to vegetation. FIG. 1 illustrates bracket 5 comprising extension 8 disposably and movably attached to base 6 to preferably provide horizontal extension or retraction of extension 8 out of or into base 6. Base 6 is disposably attached to support 12 at any height desired or required for the delivery of water to vegetation. Water supply tube 14 is disposably attached to a main water supply tube (not shown) and disposably attached to support 12 from ground level along support 12 via fasteners 18, preferably comprising tube clamps.

Water supply tube 14 is disposed in opening 15 in support 12 and passes through the support and is disposed in and passes through the interior of base 6 and extension 8. Tube 14 is directed vertically near one end of extension 8 using a fastener comprising a 90 degree fitting as well as a short section of tube 14 (not shown). Tube 14 is attachably disposed to sprayer 20, providing water to vegetation.

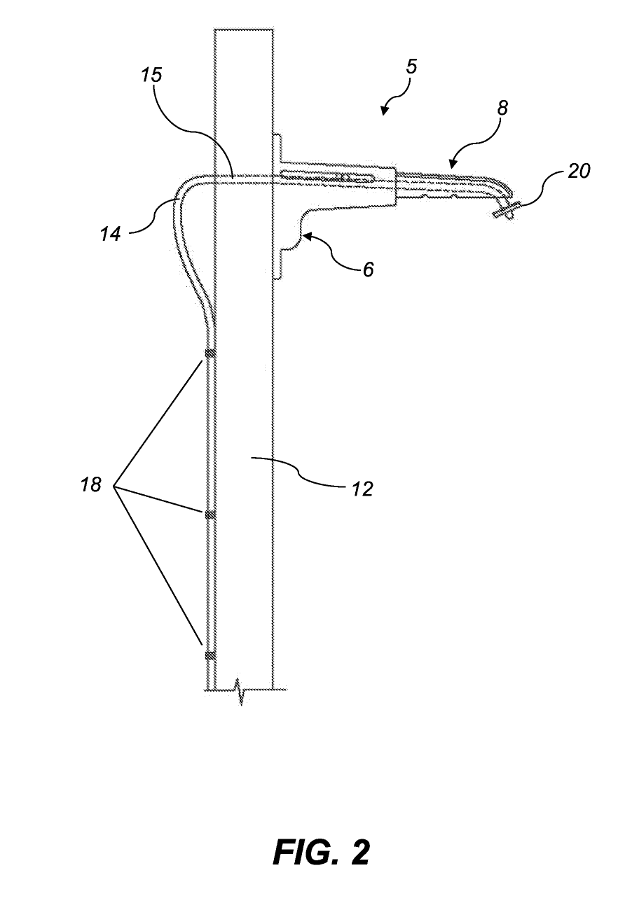

FIG. 2 is a side view illustrating bracket 5 comprising a plurality of elements. Bracket 5 is disposably attached to a support comprising an opening. A drip irrigation tube is disposed within the opening. Bracket 5 comprises drip emitter 20 that supplies water to vegetation or to any receptacle including but not limited to a bird bath or watering trough. FIG. 2 illustrates bracket 5 comprising tube 14 disposed in opening 15, directed to one end of extension 8 and then directed downward and disposably attached to drip emitter 20.

Bracket 5 comprises any number of materials manufactured using a plurality of processes to create a wide variety of alternative embodiments of the present invention. One embodiment of bracket 5 comprises a manufactured product created by an injection molding process from Acrylonitrile Butadiene Styrene (ABS), which is a high gloss, impact-resistant polymer that provides excellent functionality and balances durability and appearance with affordable manufacturing cost. Other embodiments of the present invention 5 comprise embodiments stamped or formed from a plurality of metals; cast from a variety of different metals including but not limited to brass, bronze, or aluminum; cast from composite materials; cast from polymers, resins, or structural fiberglass; made from cast materials that are subsequently machined; made from metal that has been welded and then machined; or constructed by adapting similarly shaped objects to this purpose.

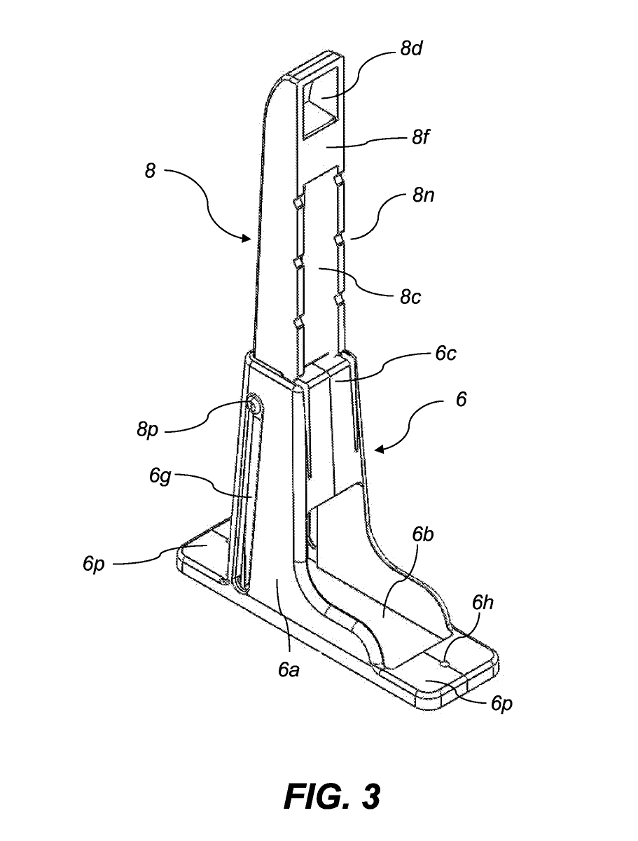

FIG. 3 illustrates a perspective view of the bracket of the present invention comprising the extension fully extended. FIG. 3 illustrates a bottom, side perspective view of bracket 5 comprising extension 8 fully extended from base 6. Base 6 comprises upper and lower arm support panels 6p and support arm 6a. Opening 6h is disposed in and preferably centered in upper and lower arm support panels 6p and comprises an opening for mounting base 6 to be disposed within. Opening 6h is positioned vertically providing access to attachably dispose a fastener comprising a screw, nail, or any other fastener, in order to attach base 6 to support 12.

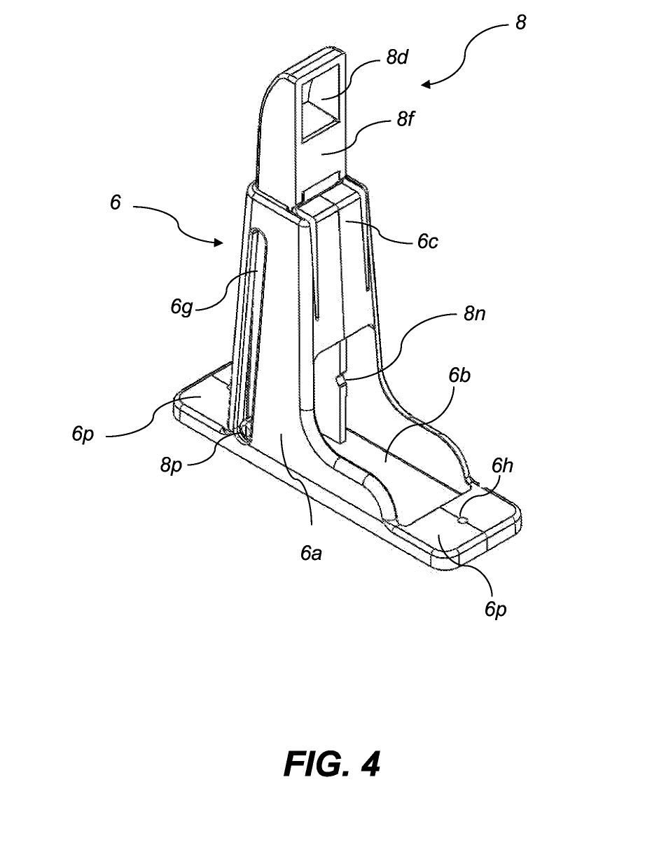

FIG. 4 illustrates an embodiment of the bracket with extension 8 in a retracted position in which upper opening 8t (not shown) and tube support 8f disposed opposite upper opening 8f are disposed outside base 6 comprising front opening 6f (not shown).

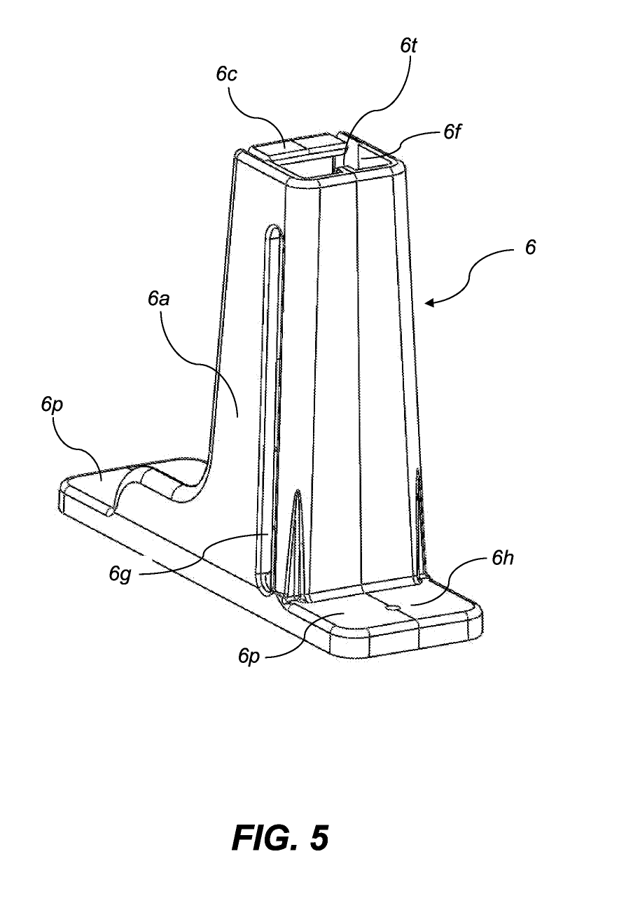

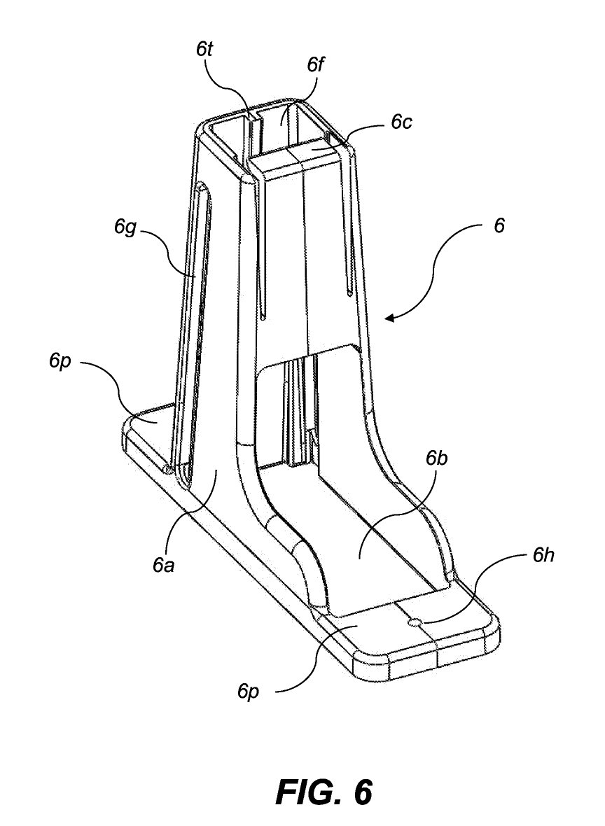

FIG. 5 illustrates a perspective view of one side of one embodiment of a base of the present invention. FIG. 6 illustrates a perspective view of another side of the embodiment of a base of the present invention.

Support arm 6a is attachably disposed to upper and lower support panels 6p, shown in FIGS. 3 and 4. Support arm 6a thus connects upper and lower support panels 6p. In the embodiment shown, support arm 6a and upper and lower support panels 6p comprise a single element. Support arm 6a comprises a hollow element extending from support panels 6p and attachably disposed to support 12. Support arm 6a comprises opening 6b, extension guide slots 6g, extension guide tab 6t that protrudes from the inside of the upper portion of support arm 6a, front opening 6f through which extension 8 is disposed, and spring catch 6c forming the lower edge of front opening 6f.

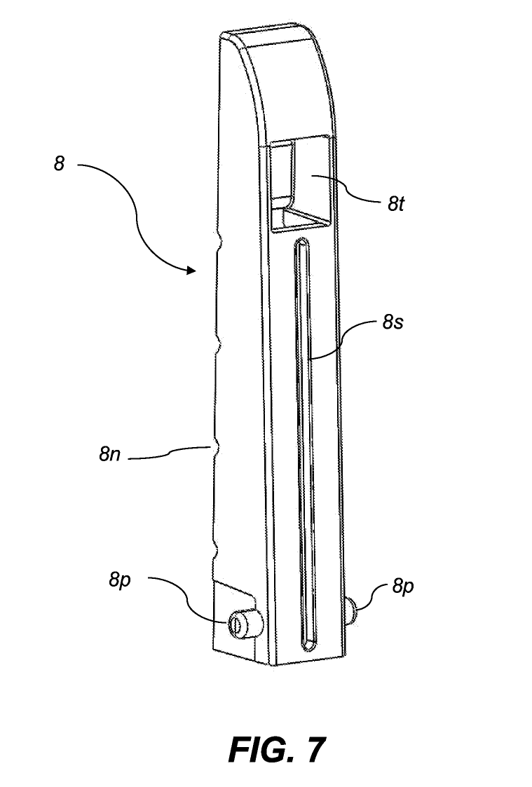

Base 6 comprises extension 8. Extension 8 is disposed within rear opening 6b which is disposed in base 6. Extension 8 is also disposed within front opening 6f of base 6 prior to disposing base 6 on support 12. Stabilizing slot 8s disposed in extension 8, as illustrated in FIG. 7, is disposed onto tab 6t on the inside, top side of opening 6f at the front of base 6 during the process of disposing extension 8 through rear opening 6b, as illustrated in FIG. 6

Tab 6t, when disposed in stabilizing slot 8s, provides lateral stability for extension 8 when extension 8 is less than fully extended keeping extension 8 centered within opening 6f throughout its length of travel. Support arm 6a comprises guide slots 6g on both side walls, along its length, and parallel to the line of the upper wall of base 6. Posts 8p disposed on the sides of extension 8 are secured within guide slots 6g disposed on the sides of support arm 6a when fully inserted into support arm 6a. Posts 8p maintain the vertical stability of extension 8 as extension 8 moves throughout its range of movement, thus keeping extension 8 parallel with the ground and perpendicular to upright 12.

Extension 8 is easily adjusted to the desired horizontal position after being fully inserted into support arm 6a by moving extension 8 out of support arm 6a or moving extension 8 in and allowing catch 6c to lock into any of the sets of indentations 8n disposed in extension 8.

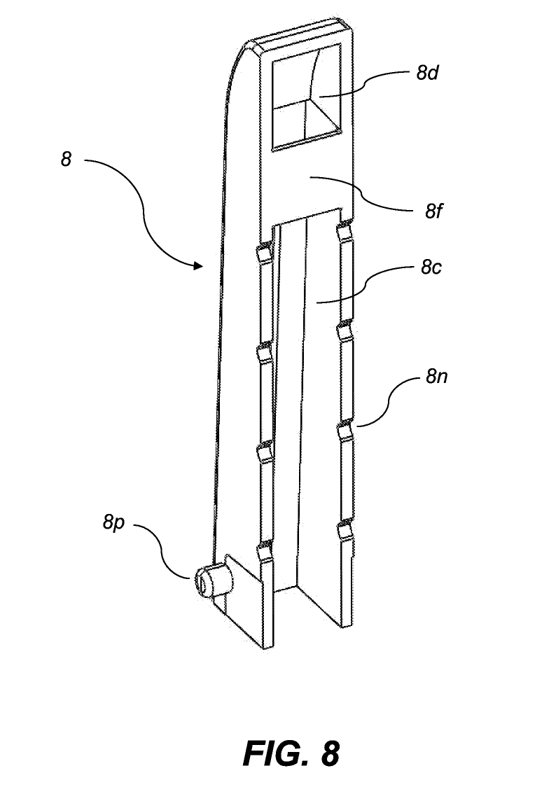

FIG. 7 is a top and side perspective view of one embodiment of the extension of the present invention shown in FIG. 2. FIG. 8 is a bottom and side perspective view of one embodiment of the extension of the present invention shown in FIG. 2.

In this embodiment, extension 8 comprises a multi-sided structure comprising indentation 8c disposed in extension 8 in which tube 14 is disposed within span indentation 8c and adjacent to tube support 8f. Tube support 8f is disposed adjacent to one side of extension 8, thus creating lower opening 8d for tube 14 to exit extension 8 in a downward orientation and supporting tube 14, and creating opening 8t in the top wall of extension 8 opposite tube support 8f that allows tube 14 to exit extension 8 vertically.

Indentations 8n are disposed on one side of the side walls of extension 8. Spring catch 6c securely attaches extension 8 both vertically by applying upward pressure, keeping upper face of extension 8 flush with the inside of opening 6f, and also securely attaches extension 8 horizontally with the upward edge of spring catch 6c disposed securely in indentations 8n on both sides of extension 8. Side posts 8p protrude from the side walls at one side of extension 8 and fit into guide slots 6g disposed in base 6. Extension 8 comprises a dimension such that extension 8 fits inside front opening 6f of base 6. comprises another dimension such that when extension 8 is retracted into base 6, upper opening 8t and tube support 8f disposed opposite upper opening 8f remain disposed exterior of front opening 6f of base 6.

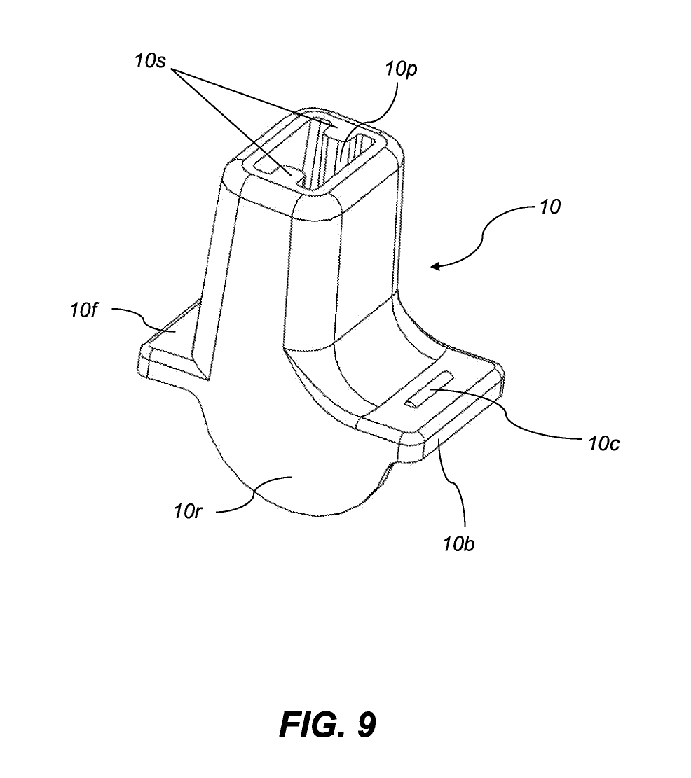

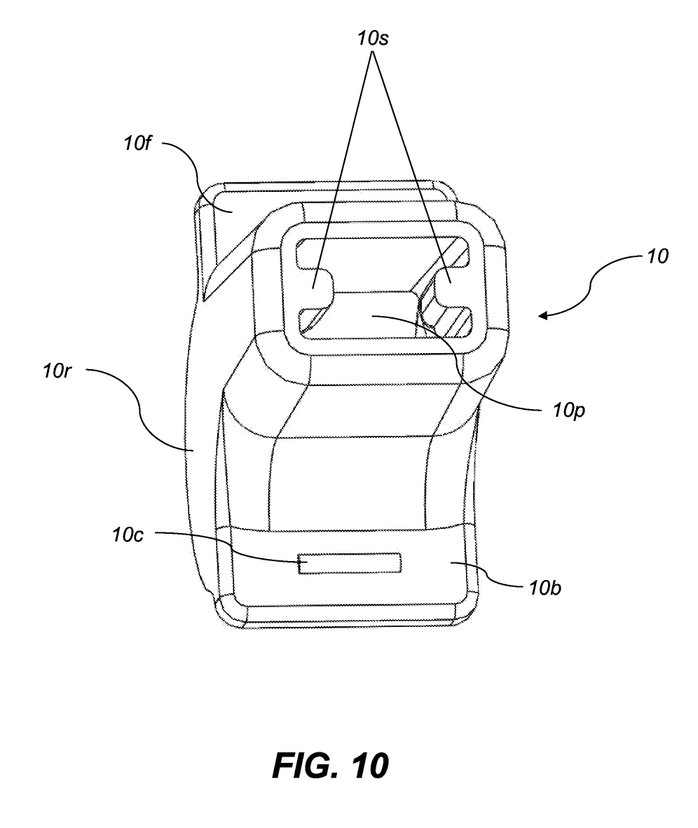

FIG. 9 is a top and side perspective view of one embodiment of a vertical support housing of the present invention. FIG. 10 is a top perspective view of one embodiment of a vertical support housing of the present invention. FIGS. 9 and 10 illustrate vertical support housing 10 vertically securably attached to tube 14, preferably to another section of tube 14 (not shown) providing for water to be directed vertically through opening 8t which is disposed in extension 8. This directional change is accomplished by the use of a ninety (90) degree fitting (not shown) disposed in tube 14 which directs the water flow vertically. To accomplish this, tube 14 is extendably disposed through opening 8t where an appropriately sized ninety (90) degree tube fitting (not shown) is attached and positioned such that it points vertically when disposed in and secured to extension 8.

The section of tube 14 is then attached to another side of the ninety (90) degree fitting (not shown). The section of tube 14 is disposed between rocker legs 10r of vertical support housing 10, and also disposed through vertical tube passage 10p whereby side flanges 10s securably attach tube 14 in a vertical position once vertical support housing 10 is securably attached within extension 8. The ninety (90) degree tube fitting (not shown) is disposed flush with vertical support housing 10 whereby the section of tube 14 extends substantially from vertical tube passage 10p. Vertical support housing 10 wherein tube 14 is disposed, and connected by the ninety (90) degree fitting (not shown) is then disposed within opening 8t so that back tab 10b moves under the rear edge of opening 8t.

Vertical support housing 10 comprises front tab 10f. Once fully inserted, vertical support housing 10 is rotatably disposed on rocker legs 10r until front tab 10f. is movably disposed adjacent to an edge of opening 8t and vertical support housing 10 is movably disposed in a direction closer to an end of extension 8 until vertical support housing 10 is secured by catch 10c is disposed adjacent to rear edge of opening 8t. A sprinkler or sprayer fitting is then secured to one end of the section of tube 14 as desired.

In another embodiment, support 12 comprises a structure including but not limited to a building, a wall, a fence, a tree, or a free-standing rigid support made of any suitable material, in any size, and with a cross-section of any shape (square, rectangular, circular, or flat) sufficiently rigid and strong to support bracket 5 of the present invention. In the embodiment illustrated in FIG. 1 and FIG. 2, for example, a standard piece of lumber with a cross-section sufficient to adequately support the bracket in use at the height above the ground required for placement of the bracket to effectively deliver water is employed. The bracket is easily attached to such a support with two fasteners comprising screws.

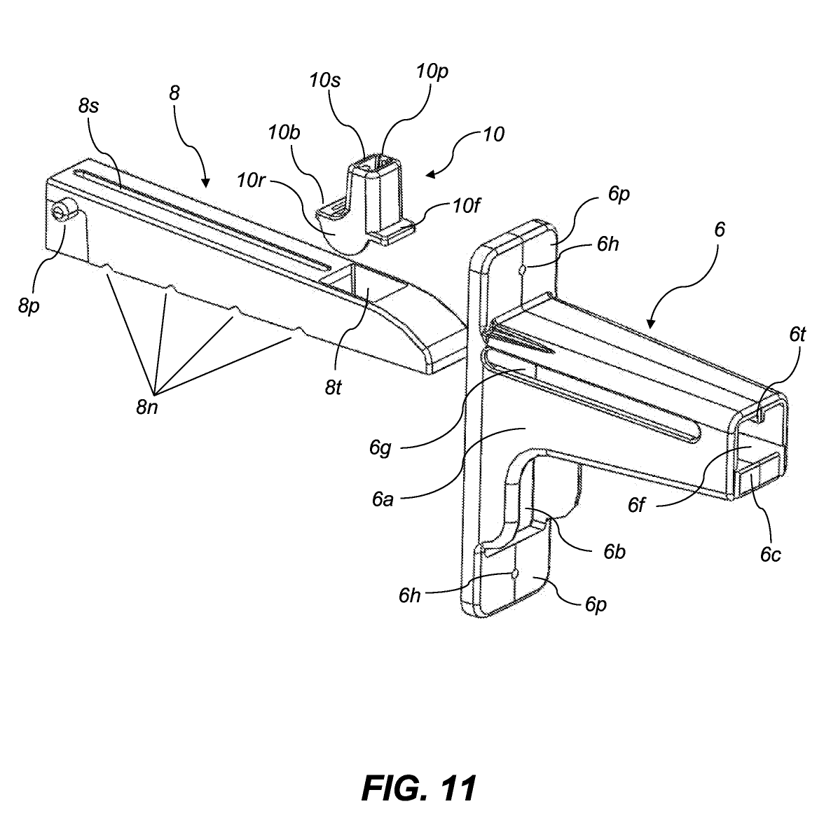

FIG. 11 illustrates a top front exploded perspective view illustrating a disassembled embodiment of the present invention. FIG. 11 illustrates extension 8 positioned to be inserted through a side of base 6 as well as vertical support housing 10 positioned to be inserted into an opening on a side of extension 8 after the extension has been positioned within the base.

The method of use of bracket 5 of the present invention is illustrated in FIG. 1 and FIG. 2. In the embodiment shown, bracket 5 is assembled by positioning extension 8 into base 6 from a side whereby posts 8p are secured in guide slots 6g. Base 6 is subsequently attachably disposed to support 14 and secured using fasteners comprising screws (not shown). Extension 8 is movably disposed to a desired position where extension 8 is secured by catch 6c when disposed in indentations 8n. A section of tube 14 is then attached to support 12 so that tube 14 extends the combined length of base 6 and extension 8. Tube 14 is positioned such that the tube is disposed exterior to either upper opening 8t or lower opening 8d of extension 8. Tube 14 is securely disposed adjacent to a side of support 12 or is disposed through a pre-drilled opening in support 12 and securely disposed adjacent to a side of support 12.

FIG. 1 illustrates the bracket securely disposed adjacent to vertical support 12 with tube 14 disposed within and extending from an opening in support 12. Tube 14 is then secured to a side of support 12 by tube clamps 18 and secured to the ground where tube 14 is connected to a water supply. In this embodiment, tube 14 is directed vertically at one end of extension 8 by vertical support housing 10. A mini-sprinkler or sprayer 61 is attachably disposed adjacent to tube 14.

FIG. 2 shows the bracket in the same embodiment as FIG. 1 but configured without vertical support housing 10 and tube 14 directed out the end of extension 8 through the lower opening 8d in a downward fashion with a drip emitter 61 attached.

An end of tube 14 is connected to a water supply when the tube is configured to deliver water at the height and in the manner desired. Typically, in a residential drip irrigation system, a water supply comprises a tube that is connected to a valve at one end and is either capped at the other end or reconnected to itself near the point of origin at the valve to create a loop. The valve is typically controlled by an automatic timer to open and close the valve at set times for set intervals. The amount of water delivered is controlled by the amount of time the water is scheduled to run in combination with the flow rate of drip emitter(s), sprinklers, or sprayers 20 used.

Alternately, a simple control valve is spliced into tube 14 between a water supply and any particular drip emitter, sprinkler or sprayer 20 so the volume of water is restricted or shut off. Alternatively, tube 14 is connected to an adapter by which it is connected directly to a hose or faucet. In this configuration, the water is manually fed to the emitter, sprinkler or sprayer by turning the water on or off.

There are many design and manufacturing alternate embodiments of the bracket of the present invention. The embodiment described above as illustrated in FIG. 1 through FIG. 11 comprises a multi-piece apparatus that is mounted at any height and is easily adjustable horizontally within some limited range. However, in instances in which no horizontal variability is required, the bracket is manufactured as a one piece decorative support for tube 14 that accommodates tube 14 and the emitters, sprayers, or sprinklers required for the particular configuration of water delivery. In this embodiment, the bracket mimics the appearance of the embodiment illustrated in FIG. 1 through FIG. 11 by manufacturing it such that support arm 6a is similar in length to the embodiment illustrated in FIG. 1 through FIG. 11 comprising a support arm 6a and extension 8 and comprising an end similar to the end of extension 8. Thus, extension 8 is eliminated together with those elements of base 6 that are associated with extension 8 comprising guide slots 6s, tab 6t, and catch 6c.

A one piece embodiment of the present invention comprises any other form or design that serves the function and purpose of elevating a water supply tube to some level above the ground and directing attached emitters, sprinklers, or sprayers for delivery of water to a receptacle or to deliver water to vegetation at a lower height.

Conversely, there are situations where more horizontal variability is required than is provided by the embodiment illustrated in FIG. 1 through FIG. 11. In this situation, an extension is manufactured in two or more pieces, of variable length and construction, to allow tube 14 to be extended horizontally at a greater distance from support 12. This is accomplished in a variety of methods. Several separate pieces are fastened to each other, added, or removed in order for the extension to be adjustable in length as required.

Also in this embodiment, a section is attached at the end of extension 8 by a fastener comprising a bolt and wing nut to enable rotation of the piece in a horizontal direction and then secured to direct the water appropriately. This is the case, for example, where the bracket must be placed at an angle to the receptacle or area to be watered that is not conducive to efficient delivery of the water to the affected area or receptacle.

Yet another embodiment comprising horizontal variability comprises a one piece base or extension comprising a plurality of sections that telescope similar to that of a collapsible radio antenna. Thus, the length of the extension is adjusted as required or desired.

Vertical adjustability is provided via elements comprising a track along with the bracket that is attached to support 12 in a vertical orientation with fasteners comprising screws. The bracket is movably disposed vertically on the track and is secured to a desired position. There are a plurality of track configurations and materials, including a material identical to base 6 material. Thus, the present invention is adjusted to a desired height and then secured with a variety of fasteners.

In a final embodiment, base 6 of the present invention comprises extensions 8 that serve a variety of purposes related to the delivery of water through automatic drip irrigation systems to elevations significantly above the level of a water line. Regardless of the actual design of base 6 and extension 8, the base and extension are constructed such that extension 8 fits into base 6, and is adjustable horizontally. This allows for any number of different extensions 8, all of which fit base 6 and adjust horizontally. Each of the different extensions 8 perform in a different capacity with respect to the end delivery of water. For example, one extension 8, the preferred embodiment, routes the drip tube and emitter over the lip of a bird bath and directs the drip tube downward to deliver water into the bird bath.

A different extension 8 is configured such that mini sprinklers or sprayers are attached. Still another extension 8 raises the drip tube to a height where it is continued along the ground to deliver water from drippers, which is useful in a raised garden area. Another embodiment of extension 8 fills pet water containers.

The of the various embodiments of the present invention comprising an adjustable, decorative support bracket described herein is used in any number of applications where it is necessary or desired to elevate the delivery point of water in an irrigation system or other type of water supply system in ways that extend functionality and provide stable, safe, adjustable, and aesthetically appealing solutions.

Furthermore, the bracket of the present invention provides the following additional advantages. The bracket is mounted at a plurality of any heights on a plurality of stable supports; the bracket permits water to be directed from the bracket through the use of a plurality of fittings and attachments comprising sprinklers, sprayers, drippers, and misters; the bracket is easily installed, configured, and maintained using readily available off-the-shelf elements; water supply tubes are secured to eliminate tripping hazards, damage by animals, or damage to vegetation; water supply tubes can be hidden to improve the aesthetics of a garden area; and the bracket allows regular filling of receptacles for wildlife in a manner that is efficient and conserves water.

Although the description above contains much specificity, this should not be construed as limiting the scope of the embodiments but as merely providing illustrations of some of several embodiments. For example, the bracket comprises other cross sectional shapes including but not limited to triangular, oval, or cylindrical. The bracket comprises one piece or several pieces configured and adjustable in any of a variety of ways including, but not limited to telescoping “antenna-like” sections, interlocking sections, or sections connected by screws or bolts. Thus, the scope of the embodiments should be determined by the appended claims and their legal equivalents rather than by the examples given.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A water delivery system comprising:
a bracket comprising:
a support;
a base variably attached to said support;
an extension attachably disposed on said base; and
a tube disposed adjacent to said support and through an opening within said base and said extension.

2. The tube of claim 1 further comprising a water delivery tube.

3. The base of claim 1 wherein said base is variably attached to said support to provide water at a variety of heights.

4. The water delivery system of claim 1 further comprising fasteners securing said tube to said support.

5. The water delivery system of claim 1 further comprising a sprinkler attached to an end of said water delivery tube.

6. The water delivery system of claim 1 further comprising a sprayer attached to an end of said water delivery tube.

7. The base of claim 1 comprising a support arm connecting upper and lower support panels

8. A method of delivering water comprising:
providing a bracket attached to a support;
variably attaching a base to the support;
attaching an extension to the base; and
attaching a tube to the said support and through an opening within the base and the extension.

9. The method of delivering water of claim 8 further comprising attaching a sprinkler to one end of the water delivery tube and attaching a main water supply to the other end of the water delivery tube.

10. The method of delivering water of claim 8 wherein the water delivery tube is directed vertically.

11. The method of delivering water of claim 8 wherein the water delivery tube is directed horizontally.

12. The method of delivering water of claim 8 wherein the water delivery tube is positioned at a variable height above vegetation.
